(19) United States
(12) Patent Application Publication
(10) Pub. No.: US 2026/0298041 A1
(43) Pub. Date: Oct. 1, 2026

(54) Collection device for corner regions

(71) Applicant: Hilti Aktiengesellschaft, Schaan (LI)

(72) Inventors: Helmut SPECHT, Irsee (DE); Philipp LORENZ, München (DE); Bernhard KUNZ, Schaan (LI); Gabor VIDA, Chur (CH); Goran GOLUBOVIC, Buchloe (DE); Claudiu Radu SANTEIU, Buchs (CH)

(21) Appl. No.: 19/577,832

(22) Filed: Mar. 25, 2026

(30) Foreign Application Priority Data
Apr. 1, 2025 (EP) 25167798.5

(51) Int. Cl. E21B 21/015

(52) U.S. Cl. CPC E21B 21/015

(57) ABSTRACT

A collection device (200) for collecting drill sludge (B) or dust created during the operation of a core drilling device is provided, the device having the following: an extraction unit (202) with a drilling opening (208) which extends through the extraction unit (202) and is designed to receive a drill bit, wherein the extraction unit (202) has a cavity which extends at least partially about the drilling opening (208), and at least one suction unit which is connected to the extraction unit and is designed to form a vacuum chamber conjointly with a surface, in particular wall or ceiling surface, wherein the vacuum chamber of the suction unit (204, 206) is fluidically separated from the cavity of the extraction unit (202).

This claims the benefit of European Patent Application EP 25167798.5, filed on Apr. 1, 2025 which is hereby incorporated by reference herein.

The present invention relates to a collection device for collecting drill sludge or dust created during the operation of a core drilling device.

### BACKGROUND

In the field of core drilling devices, various devices are known for collecting drill sludge produced when carrying out core drilling. For example, water trap rings are known that can be attached to the substrate using mechanical fastening means, such as clips or clamping means. Other devices are attached to a substrate by means of a vacuum created by a suction device.

### SUMMARY OF THE INVENTION

However, the mechanical fastening means are associated with the disadvantage that they often cannot be removed from the substrate in a non-destructive manner, and therefore minor damage to the substrate cannot be ruled out.

When fastening the water trap rings with a vacuum, the issue lies in that the water trap ring can only be fastened to the substrate and held thereon when a suction unit of a water treatment device is switched on and operational. However, continuous operation of the suction unit is not required to perform the core drilling, and suction devices consume a particularly large amount of electrical power, especially when idle. This disadvantage weighs even more heavily when battery-powered suction devices are used, which have only a limited amount of on-board power due to their supply of electrical power from batteries or the like. However, even if mains-powered water treatment devices are used, fastening conventional water trap rings by means of a suction device leads to unnecessarily high energy consumption. Moreover, continuous operation of the water treatment device can lead to increased noise pollution on a construction site.

It is furthermore disadvantageous that known water trap rings can only be fastened to the substrate while a suction device is in operation, so that the drilling location or the construction site cannot be prepared for carrying out the core drilling operation. However, this would be desirable for an efficient flow of work on a construction site.

An object on which the present invention is based is that of overcoming the above-described shortcomings and disadvantages of the prior art, and of providing a collection device for collecting drill sludge by which the execution of core drilling operations can be assisted efficiently in terms of time and energy. In particular, when the collection device to be provided is used in conjunction with a battery-powered suction device to remove drill sludge from the working area of a core drilling device, the system is not intended to shorten the running time of the battery-powered suction device, but to contribute toward increasing the range of a “battery charge”. In addition, the collection device should be easy and straightforward to fasten to a substrate and should ensure good adhesion to various surfaces, even rough ones. Furthermore, the industry would welcome a suitability of the system to be provided for different drill bit sizes of a core drilling device.

Based on the above-mentioned set of issues, it is an object of the present invention to provide a collection device that is used energy-efficiently conjointly with a battery-powered suction device to remove drill sludge from the working area of a core drilling device. The collection device is not intended to shorten the running time of the battery-powered suction device, but to contribute toward increasing the range of a “battery charge”. Moreover, the system should be easy and straightforward to attach to a substrate and should ensure good adhesion to various surfaces, even rough ones. Furthermore, the industry would welcome a suitability of the collection device to be provided for different drill bit sizes of a core drilling device.

The present invention provides a collection device for collecting drill sludge (B) or dust created during the operation of a core drilling device, the device having the following:
an extraction unit with a drilling opening which extends through the extraction unit and is designed to receive a drill bit, wherein the extraction unit has a cavity which extends at least partially about the drilling opening;
at least one suction unit which is connected to the extraction unit and is designed to form a vacuum chamber conjointly with a surface, in particular wall or ceiling surface,
   wherein the vacuum chamber of the suction unit is fluidically separated from the cavity of the suction unit.

The invention can provide a collection device that can be fastened to a substrate independently of the core drilling device and/or an external suction device. Application tests have shown that the collection device can be fastened to a substrate particularly easily and quickly on site, so that rapid readiness for use can be ensured. In particular, the system can be fastened to the substrate prior to actually commencing the drilling operation, since the vacuum used to fasten the collection device is generated by a separate vacuum pump. In this respect, the fastening of the proposed collection device is independent of the use or operation of a water treatment device used for vacuuming the drill sludge. Moreover, the invention can reduce noise emissions at a construction site, and can also reduce energy consumption.

According to a further embodiment, the extraction unit is of a substantially annular design. Due to the annular design of the extraction unit, the latter can have an ideally small circumference. The diameter of the annular shape of the extraction unit is essentially determined by the diameter of the corresponding drill bit. Due to the annular design of the extraction unit, the latter only has to be slightly larger than the drilling opening. Thus, the annular extraction unit can be used to ensure that the collection device can be placed as close as possible to the corner of the surface to be machined. Of course, it is alternatively also conceivable to design the extraction unit in many other shapes, such as a rectangular shape, for example.

According to a further embodiment, the at least one suction unit covers between 40% and 75% of an external circumference of the extraction unit. According to this embodiment, at least one quarter of the external circumference of the extraction unit remains free of the at least one suction unit. The at least one quarter can therefore be incorporated as far as possible into a corner region, wherein the suction units do not impede the insertion of the extraction unit into the corner region, as this will be illustrated in more detail hereunder. By covering at least 40% of the external circumference of the extraction unit, it is also ensured that the extraction unit is firmly attached to the substrate. In particular, it prevents the extraction unit from moving relative to the suction unit. This will prevent damage to the collection device.

According to a further embodiment, the collection device has a first and a second suction unit, wherein the two suction units are mutually spaced apart in the circumferential direction of the extraction unit. According to this example, the extraction unit is fastened to the surface to be machined at two different, i.e. mutually spaced apart, locations. This results in greater stability. At the same time, the second suction unit can prevent twisting of the collection device. For example, the two suction units can be attached to mutually opposite sides of the extraction unit. The suction units are designed to be substantially wing-like.

According to a further embodiment, the first suction unit has a substantially axially symmetrical external contour in relation to the second suction unit. The symmetrical design of the two suction units has advantages in production, as many constituent parts of the suction units can be manufactured simultaneously or on the same machines. For example, the two suction units can have identical seals to seal the vacuum chamber in relation to the surface to be machined. The symmetrical design moreover has the advantage that the collection device can be attached in the same way in each corner of the wall or ceiling surface to be machined.

According to a further embodiment, the first suction unit is fluidically connected to the second suction unit, in particular via an air duct which is at least partially formed by the extraction unit. Due to the fluidic connection between the two suction units, it is sufficient for only one of the two suction units to be equipped with a suction connection. The air duct can accordingly be used to draw the air from both vacuum chambers of the two suction units by way of a single suction connection. Due to the integral design of the air duct in the extraction unit, the space requirement of the collection device according to the invention is further reduced, since no additional external structures (external air ducts) are necessary.

According to a further embodiment, the first suction unit has a first lateral surface which extends substantially perpendicularly to a first lateral surface of the second suction unit, wherein the two first lateral surfaces of the suction units are mutually spaced apart in the circumferential direction of the extraction unit. Due to the perpendicular arrangement of the first lateral surfaces of the two suction units, the collection device according to the invention can be moved better into the corner regions of the surface to be machined. This is therefore the case in particular because the wall or ceiling transitions are likewise typically mutually perpendicular. The first sides of the suction units can thus cling to the wall or ceiling surface in order to reach as far as possible into the corner region.

According to a further embodiment, the first lateral surfaces of the first and the second suction unit are disposed substantially tangentially to the external circumference of the extraction unit. Due to the tangential arrangement of the first lateral surfaces of the suction unit in relation to the external circumference of the extraction unit, it is ensured that only the diameter of the annular extraction unit is a restricting factor for the spacing of the drilling opening from the corner of the wall. It should be mentioned at this point that according to the present invention, only one suction unit may also be provided. Also in this case, it is advantageous to provide the individual suction unit with a first lateral surface, which is arranged tangentially to the external circumference of the extraction unit. The same advantages can be achieved as a result.

According to a further embodiment, the first suction unit has a second lateral surface which is substantially opposite the first lateral surface, wherein the second suction unit has a second lateral surface which is substantially opposite the first lateral surface, and wherein the two second lateral surfaces of the extraction units are mutually spaced apart in the circumferential direction of the extraction unit, wherein the spacing of the two lateral surfaces is sized in such a manner that at least a part of a drill stand can be disposed between the second lateral surfaces. According to this embodiment, the two suction units are mutually spaced apart not only on their first lateral surface, but also on their second lateral surface. In other words, the suction units are mutually spaced apart in the counter-clockwise direction, on the one hand, and in the clockwise direction, on the other. The spacing as well as the contour of the second lateral surfaces can be selected in such a manner that they are adapted to a front end of the drill stand. For example, the spacing or the contours of the second lateral surfaces may be designed in such a manner that they enclose the front end of the drill stand.

According to a further embodiment, the at least one suction unit is of a substantially triangular or partially annular design. On the one hand, the triangular shape has the advantage that the suction units can be brought particularly close to the corner regions while simultaneously providing as large a void as possible between the second lateral surfaces for the arrangement of the drill stand.

According to a further embodiment, the at least one suction unit has a suction nozzle which is designed to be connected to a suction hose of a vacuum pump during operation.

According to a further embodiment, the at least one suction unit has a seal for sealing the vacuum chamber in relation to the surface, and wherein the suction nozzle is disposed on a surface of the suction body that lies opposite the seal.

According to a further embodiment, the extraction unit has a seal for sealing the cavity in relation to the surface.

According to a further embodiment, the extraction unit has at least one extraction opening which is disposed on an inner wall of the cavity and serves to extract drill sludge or dust from the cavity, wherein the extraction opening is connected to an extraction nozzle via an extraction duct, and wherein the extraction nozzle is connected to the external circumference of the extraction unit.

According to a further embodiment, the extraction nozzle overlaps the at least one suction unit and/or is part of the suction unit. Thus, the suction units also imparts stability to the extraction nozzle. At the same time, the overlapping arrangement guarantees that the spacing of the drilling opening from the corner region is not limited by the extraction nozzle.

A further aspect of the present disclosure relates to a collection device for collecting drill sludge or dust created in the operation of a core drilling device, the device comprising:
an extraction unit with a drilling opening which extends through the extraction unit and is designed to receive a drill bit, wherein the extraction unit has a cavity which extends at least partially about the drilling opening;
a first suction unit which is connected to the extraction unit and is designed to form a vacuum chamber conjointly with a surface, in particular wall or ceiling surface,
a second suction unit which is connected to the extraction unit and is designed to form a vacuum chamber conjointly with a surface, in particular wall or ceiling surface,
   wherein the two suction units are mutually spaced apart in the circumferential direction of the extraction unit.

A further aspect of the present disclosure relates to a collection device for collecting drill sludge or dust created in the operation of a core drilling device, the device comprising:
an extraction unit with a drilling opening which extends through the extraction unit and is designed to receive a drill bit, wherein the extraction unit has a cavity which extends at least partially about the drilling opening;
at least one suction unit which is connected to the extraction unit and is designed to form a vacuum chamber conjointly with a surface, in particular wall or ceiling surface,
wherein the at least one suction unit has a first lateral surface which is aligned so as to be substantially parallel to a tangent of an external circumference of the extraction unit.

According to a further embodiment, the first lateral surface of the suction unit extends on the tangent of the external circumference of the extraction unit.

### BRIEF DESCRIPTION OF THE DRAWINGS

Further advantages are derived from the description of the figures hereunder. The figures, the description and the claims contain numerous features in combination. A person skilled in the art will expediently also consider the features individually and combine them to form further useful combinations.

In the drawings:

FIG. 1 shows a schematic illustration of a core drilling system with a collection device;

FIG. 2 shows a perspective view from below of a collection device according to an embodiment of the present invention;

FIG. 3 shows a perspective view from above of the collection device according to FIG. 2;

FIG. 4 shows a view from below of the collection device according to FIG. 2;

FIG. 5 shows a schematic illustration of a collection device according to one embodiment of the present invention;

FIG. 6 shows a top view of a core drilling system with a collection device according to an embodiment of the present invention; and

FIG. 7 shows a top view of a core drilling system with a collection device according to an embodiment of the present invention.

### DETAILED DESCRIPTION

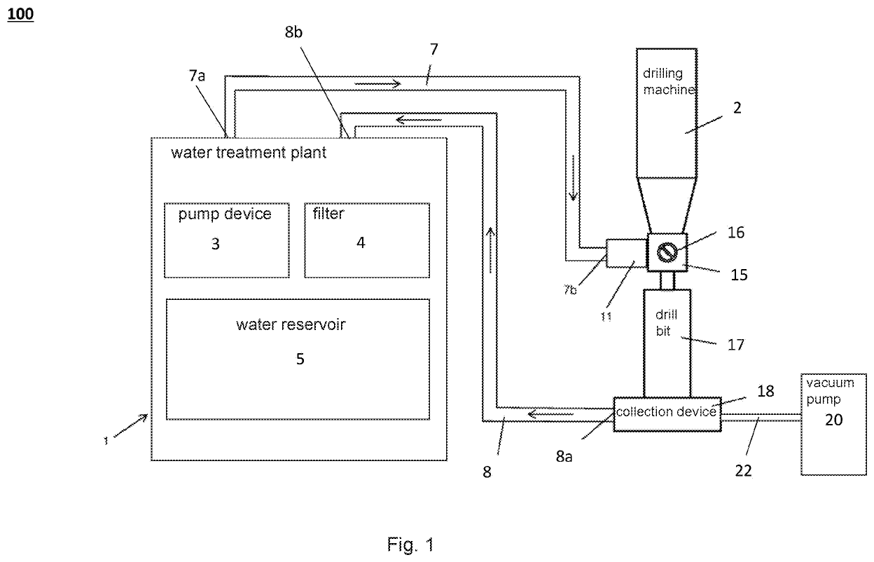

FIG. 1 shows a core drilling system 100. The core drilling system 100 has a treatment device 1 which is designed as a water treatment plant and is connected to a power tool 2 designed as a core drilling machine. The core drilling machine 2 is connected to a tool 17 designed as a drill bit. The treatment device 1, designed as a water treatment plant, is designed to provide cooling water at the tool and to extract and clear consumed cooling water/drill sludge.

The water treatment plant 1 substantially contains a housing, a water reservoir 5, a drill sludge reservoir, a filter 4, a first line 7, a second line 8, a pump device 3 and a control device.

The housing is essentially designed as a hollow container. Moreover, on an external side the housing contains an interface for the supply of an electrical voltage, for example a battery holder. Both the water reservoir 5 and the drill sludge reservoir are positioned in the housing. The water reservoir 5 is used to store a supply of fresh water for cooling and flushing.

The drill sludge reservoir is substantially designed in the form of a cylindrical container. The lateral walls and the bottom are formed as a filter 4 and therefore consist of a filter-like material, which is suitable to retain the drill sludge and only allow water to penetrate. The drill sludge reservoir and the water reservoir 5 are in particular mutually positioned in such a way that the water exiting the filter 4 of the drill sludge reservoir is collected in the water reservoir 5.

The first line 7 is designed in the form of a flexible hose and contains a first end 7a and a second end 7b. The first end 7a of the first line 7 is connected to the water reservoir 5. The second end 7b of the first line 7 is connected to a connector 15 on the core drilling machine 2. The connector 15 contains a valve 16 by which the flow through the first line 7 can be opened and closed. The opened position of the valve 16 serves to allow water to reach the tool 17, which is designed as a drill bit, through the first line 7. The closed position of the valve 16 serves to ensure that no water can pass through the first line 7 to the drill bit 17.

The first line 7 is used to transport fresh water from the water reservoir 4 to the drill bit 17. As shown in FIG. 1, the first line 7 is connected to the core drilling machine 2 via the connector 15 in such a way that the water enters the interior of the drill bit 17. The water cools and flushes the drill bit 17 during a drilling operation. According to an alternative embodiment, it can also be provided that the first line 7 for cooling first leads through the core drilling machine 2 before finally making its way to the drill bit 17 for cooling and flushing the latter.

The second line 8 is likewise designed in the form of a flexible hose and contains a first end 8a and a second end 8b. The first end 8a of the second line 8 is connected to a collection device 18. The collection device 18 is positioned at the end of the drill bit 17 and is used to collect the drill sludge (rocks, dust and water) that occurs during the drilling procedure. The second end 8b of the second line 8 is connected to the drill sludge reservoir in such a way that the drill sludge can enter the drill sludge reservoir via the second line 8 from the collection device 18.

The pump device 3 contains a first pump portion and a second pump portion. The first pump portion is connected to the first line 7 and is used to convey or pump fresh water from the water reservoir 4 to the drill bit 17. The second pump portion is connected to the second line 8 and is used to convey or pump drill sludge from the collection device 18 into the drill sludge reservoir.

The collection device 18 can be disposed on the ground, on the one hand. In this case, it is not necessary for the collection device to be fastened to the substrate. However, in the case walls or ceilings being drilled, it is necessary for the collection device 18 to be fastened to the surface to be machined. According to the present invention, the collection device is designed in such a manner that it can be fastened to the surface to be machined by a vacuum. In other words, the collection device 18 can cling to the surface by vacuum. For this purpose, the collection device 18 has a suction unit which is not illustrated in detail and is designed to form a vacuum chamber conjointly with the surface, in particular wall or ceiling surface. A vacuum pump 20 can be connected to the suction unit via a vacuum hose 22 in order to apply vacuum to the vacuum chamber.

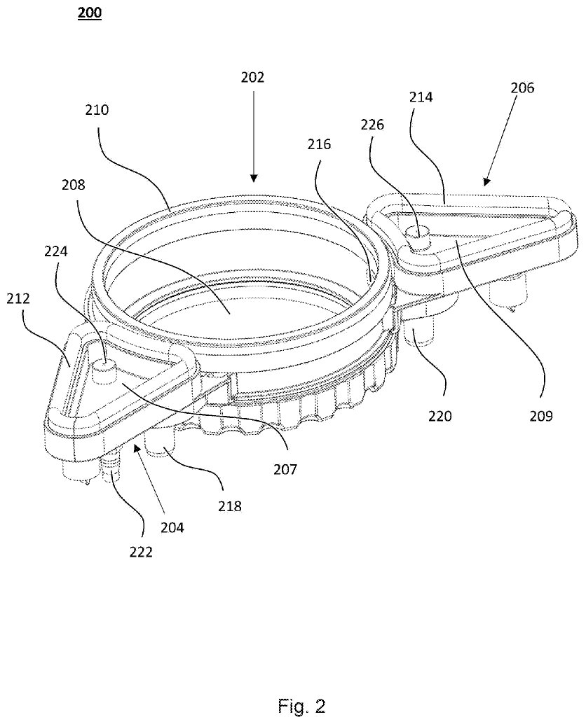

A detailed illustration of a collection device according to an embodiment of the present invention is shown in FIGS. 2 to 4. FIG. 2 shows a perspective view from below the collection device 200. The collection device 200 has an extraction unit 202. In the embodiment illustrated here, the extraction unit is in particular of an annular design. A drilling opening 208 extends through the extraction unit 202. The drilling opening 208 is designed to receive a drill bit of a core drilling device. Accordingly, the diameter of the drilling opening 208 is adapted to the diameter of the drill bit. In other words, the collection device of the present invention can have extraction units with differently sized drilling openings which are in each case tailored to the drill bit to be used.

In the embodiment illustrated here, the collection device 200 has two suction units 204, 206. As already indicated above, however, it is also conceivable that the collection device has only one suction unit.

The two suction units 204, 206, are connected to the extraction unit 202. In particular, the two suction units 204, 206 are fixedly connected to the extraction unit 202. The suction units 204, 206 cannot be moved relative to the extraction unit 202.

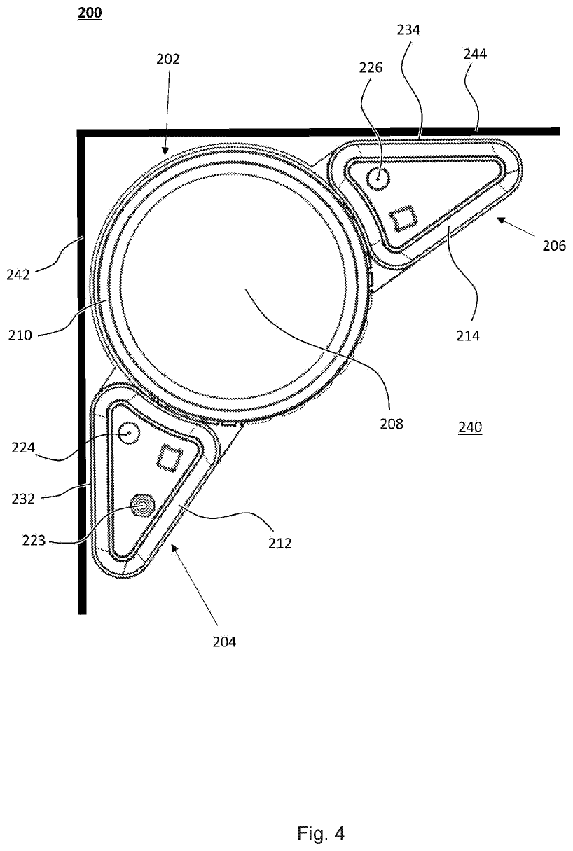

According to the embodiment in FIGS. 2 to 4, the suction units 204, 206 are of a substantially identical shape. In particular, this is a triangular shape, as will also be described in more detail with regard to FIG. 4.

The extraction unit 202 has a first seal 210. The first seal 210 of the extraction unit 202 is disposed on a lower side of the extraction unit 202. It is used to establish a sealing connection to the surface to be machined (for example, wall or ceiling surface). Conjointly with the surface to be machined, the extraction unit 202 forms a cavity which extends about the drilling opening 208. The cavity is sealed in relation to the surface to be machined by the first seal 210 in order to prevent the cooling water or drill sludge from flowing out of the interior of the extraction unit 202.

The first suction unit 204 has a second seal 212. The second seal 212 serves to seal a cavity formed in the interior of the first suction unit 204 in relation the surface to be machined. A first vacuum chamber 207 is formed by the cavity conjointly with the surface to be machined. The first vacuum chamber 207 is used to fasten the collection device 200 to the surface to be machined by vacuum.

The second suction unit 204 has a third seal 214. The third seal 214 serves to seal a cavity formed in the interior of the second suction unit 206 in relation to the surface to be machined. A second vacuum chamber 209 is formed by the cavity conjointly with the surface to be machined. The second vacuum chamber 209 is used to fasten the collection device 200 to the surface to be machined by vacuum.

The first suction unit 204 has a vacuum connection 222. In the embodiment illustrated here, the vacuum connection 222 is disposed on a side of the first suction unit 204 that lies opposite the first seal 212. In other words, the vacuum connection 222 is disposed on the upper side of the first suction unit 204.

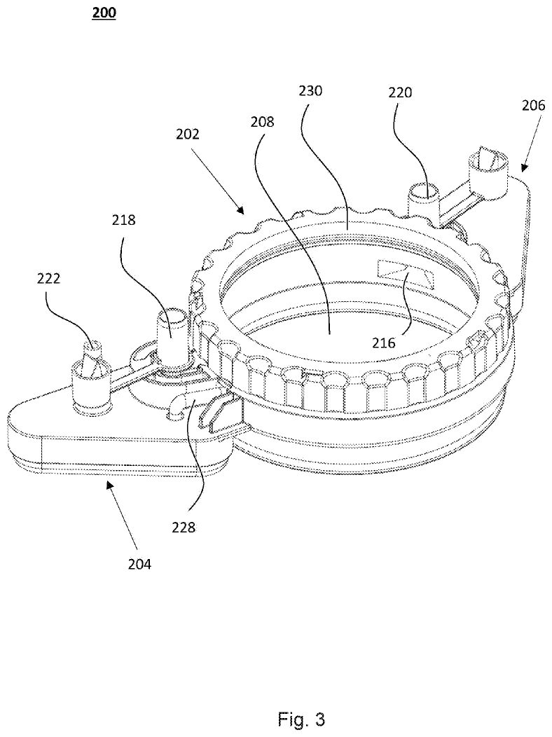

The first suction unit 204 has a first opening 224. The first opening 224 is connected to a second opening 226 of the second suction unit 206 via an air duct 228 illustrated in FIG. 3. In the embodiment illustrated here, the first opening 224 is an air inlet, while the second opening 226 is an air outlet.

The vacuum chambers 207, 209 of the two suction units 204, 206 are fluidically separated from the cavity of the suction unit 202. This is achieved in particular by the separate seals 210, 212, 214. A transfer of cooling water or drill sludge or dust from the cavity of the extraction unit 202 into the vacuum chamber 207, 209 of the suction unit 204, 206 is thus ruled out. The suction units 204, 206 are used exclusively for holding the collection device 200 on the surface to be machined. By contrast, the extraction unit 202 is used exclusively to collect drill sludge or dust, which occurs during drilling, and to discharge it to a treatment device already described above.

For fastening the collection device 200 to the surface to be machined (for example, wall or ceiling surface), vacuum is generated within the vacuum chambers 207, 209. To generate the vacuum, a vacuum hose is attached to the vacuum connection 222 of the first suction unit 204. As shown in FIG. 4, the vacuum connection 222 is connected to the vacuum chamber 207 of the first suction unit 204 via an opening 223. A vacuum can thus be generated in the first vacuum chamber 207 via the vacuum connection 222. As already mentioned above, the first vacuum chamber 207 is connected to the second vacuum chamber 209 of the second suction unit 206 via an air duct. One part of the air duct 2 28 is illustrated in FIG. 3. Another part of the air duct, not illustrated, is preferably integrated at least into the extraction unit 202.

A vacuum in both vacuum chambers 207, 209 can be achieved using a single suction connection 222 by way of the air duct between the vacuum chambers 207, 209 of the two suction units 204, 206. In particular, upon connecting the suction hose connection 222, air is drawn from the second vacuum chamber 209 via the second opening 226, the air duct and the first opening 224 into the first vacuum chamber 207. The air in the first vacuum chamber 207 is then conveyed via the suction connection 222 to a corresponding vacuum pump. The vacuum pump can be part of the treatment device. Alternatively, the vacuum pump can also be a separate device. In the embodiment illustrated, the vacuum pump only has to be connected to one of the two suction units 204, 206. Pressure is equalized between the two suction units via the air duct described above. Alternatively, however, it is also conceivable to fluidically separate the two suction units 204, 206 from one another. In this embodiment, each of the two suction units 204, 206 can be provided with a separate suction connection.

For extracting the drill sludge or dust from the cavity of the extraction unit 202, at least one extraction opening 216 is provided in the cavity. In the embodiment illustrated in FIGS. 2 to 4, in particular two extraction openings (only the second extraction opening 216 illustrated) are provided. A first extraction opening extends through the inner wall of the cavity of the extraction unit 202 in the direction of a first extraction duct. The second extraction opening 216 extends through the inner wall of the cavity in the direction of a second extraction duct. In FIGS. 2 and 3, the extraction ducts end in extraction nozzles 218, 220.

The extraction nozzles 218, 220 can be used to connect a suction hose of the treatment device. Thus, drill sludge or dust can be extracted from the cavity via the two extraction nozzles 218, 220 and conveyed to the treatment device. In operation, it is sensible that only one of the two extraction nozzles 218, 220 is connected to the treatment device at a time. The other extraction nozzle remains open. The open extraction nozzle serves as a ventilation opening by which the extraction of drill sludge or dust from the cavity is facilitated.

In the first embodiment according to FIGS. 2 to 4, the first extraction nozzle 218 overlaps the first suction unit 204. The second extraction nozzle 220 overlaps the second suction unit 206. The extraction openings extend in the direction of the first or second suction unit 206. This is therefore particularly advantageous because one of the two suction units 204, 206 when used in wall corner areas perpendicular come to lie below the extraction unit 202. The two extraction openings thus ensure that, at each orientation of the collection device 200 in the wall areas, the drill sludge runs down into one of the two extraction openings.

FIG. 4 shows the collection device 200 according to the first embodiment in an application situation. The collection device 200 is a collection device designed for corners. In FIG. 4, it is attached to a corner of a wall. For this purpose, the first and the second suction unit 204, 206 are brought as close as possible to the surfaces adjacent to the corner. In the embodiment illustrated here, the first suction unit 204 can, for example, be positioned as close as possible to a first wall surface 242. The second suction unit 206 is positioned as close as possible to a ceiling surface 244. After the two suction units 204, 206 are aligned in terms of their respective surfaces, a vacuum can be generated within the vacuum chambers 207, 209 (see FIG. 2). Thus, the collection device 200 is fastened to the surface to be machined 240 (wall surface) by the vacuum.

In order to be able to position the extraction unit 202 as far as possible in the corner region, the first and second suction units 204, 206 are aligned substantially perpendicularly to one another. In particular, the first suction unit 204 has a first lateral surface 232 which extends perpendicularly to a first lateral surface 234 of the second suction unit 206. The first lateral surface 232 of the first suction unit 204 can therefore be aligned parallel to the first wall surface 242. The first lateral surface 234 of the second suction unit 206 can be disposed parallel to the ceiling surface 244.

In the specific application according to FIG. 4, the first suction unit 204 is disposed substantially below the extraction unit 202. Accordingly, the first extraction opening (opposite extraction opening 216 shown in FIG. 2) is also disposed below the drilling opening 208, so that drill sludge or cooling water enters the extraction opening under the force of gravity and can be conveyed to the treatment device.

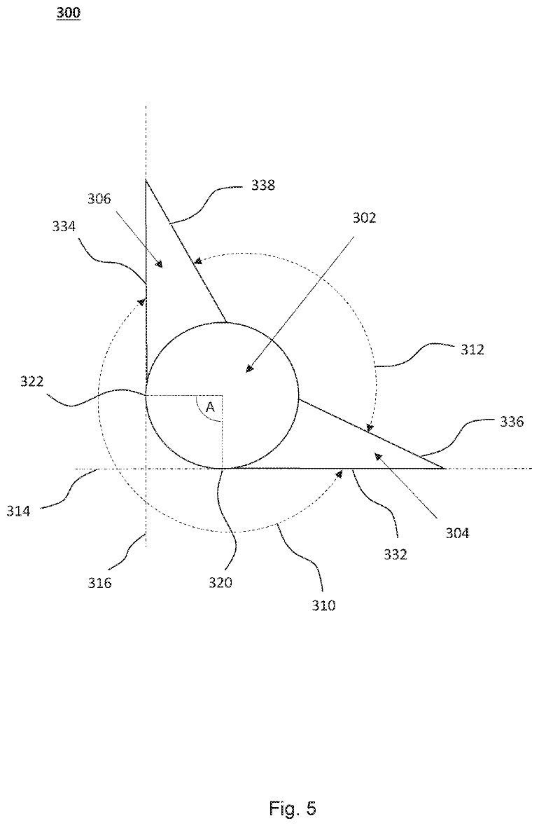

Further geometric considerations of the present invention are highlighted in FIG. 5. FIG. 5 shows a further embodiment of the collection device according to the present invention. The collection device 300 according to FIG. 5 has an extraction unit 302. The first and the second induction devices 304, 306 are connected to the external circumference of the extraction unit 302. The extraction unit 302 and the suction units 304, 306 are in terms of function substantially identical to the extraction or suction units described above and have corresponding openings or connections. The latter are not illustrated in FIG. 5 for the sake of simplicity.

In the embodiment illustrated in FIG. 5, the first lateral surfaces 332, 334 of the suction units 304, 306 are disposed tangentially to the annular extraction unit 302. In other words, the first lateral surface 332 of the first suction unit 302 is on a first tangent 314 of the annular extraction unit 302. The first lateral surface 334 of the second suction unit 306 is on a second tangent 316 of the annular extraction unit 302. The two first lateral surfaces 332, 334 are aligned perpendicularly to one another. Accordingly, the first and the second tangent 314, 316 are also aligned perpendicularly to one another. This also results in that the two first lateral surfaces 332, 334 of the first and the second suction unit 304, 306 are mutually spaced apart over an angular range 310 of 270°. Due to this spacing of the first lateral surfaces 332, 334 in the circumferential direction of the extraction unit 302, the extraction unit 302 can be placed as close as possible in the corner region. The limiting factor is not the geometry of the suction units 304, 306, but only the radius of the annular extraction unit 302. In other words, a smaller extraction unit can be placed farther into the corner region than is the case for extraction units with large radii.

The first tangent 314 touches the external circumference of the annular extraction unit 302 at a first point 320. The second tangent 316 touches the external circumference of the annular extraction unit 302 at a second point 322. Due to the perpendicular alignment of the tangents 314, 316, the two points 320, 322 are disposed on the external circumference of the annular extraction unit 202 in such a manner that the centerpoint angle A created between the two points 320, 322 is 90°. In other words, the arc of the annular extraction unit 302 exposed between the two first lateral surfaces 332, 334 is derived from the formula ½*π*r.

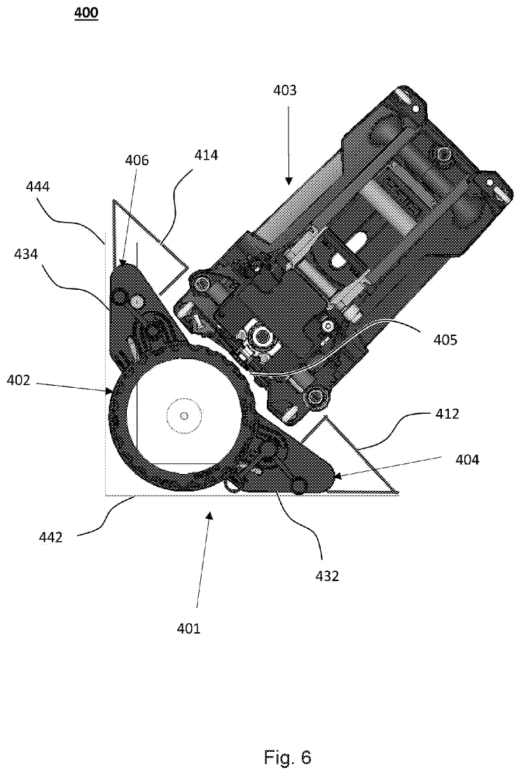

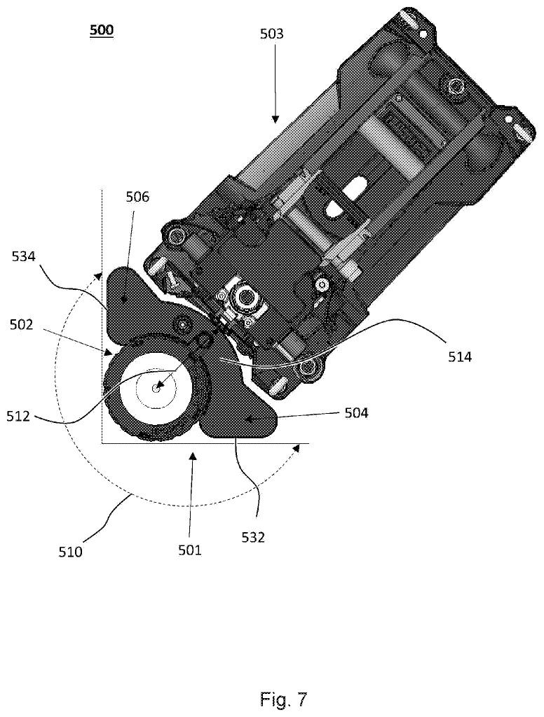

In the embodiment according to FIG. 5, the first and the second suction units 304, 306 each have a second lateral surface 336, 338. The second lateral surfaces 336, 338 are connected at a first end to the first lateral surfaces 332, 334. The second lateral surfaces 336, 338 extend at an acute angle in relation to the first lateral surfaces 332, 334. In the embodiment according to FIG. 5, the second lateral surfaces 336, 338 are also mutually spaced apart in the circumferential direction of the annular extraction unit 302. In the embodiment according to FIG. 5, the spacing is an obtuse angular range 312. Due to the mutual spacing between the second lateral surfaces 336, 338, a void opposite the corner region to which the drill stand can be fastened is created, as this will be explained in more detail, for example, with reference to FIGS. 6 and 7.

In the embodiment according to FIG. 5, the first sides 332, 334 of the first and the second suction unit 304, 306 run on the first and the second tangent 314, 316 of the annular extraction unit 302. However, any other orientation of the first sides 332, 334 is also conceivable as long as the first sides 332, 334 do not intersect the first and the second tangent 314, 316. For example, the first and the second lateral surfaces 332 and 334 can be disposed parallel and spaced apart from the first and the second tangent 314, 316. Due to a close arrangement of the first lateral surfaces 332, 334 on the tangents 314, 316 of the extraction unit, however, a particularly good utilization of the available installation space is ensured. Thus, the first and the second suction unit can have as large a surface as possible without affecting the spacing of the extraction unit from the corner region and without invading the region of the dispenser.

FIG. 6 shows a schematic top view of a core drilling system 400. The core drilling system 400 has a collection device 401 according to an embodiment of the present invention. The core drilling system 400 furthermore comprises a drill stand 403 which is used for fastening a core drilling device. The core drilling device per se is not illustrated. However, the skilled person is aware that the core drilling device should preferably drill as close as possible to the drill stand in order to minimize potential leverage forces.

The collection device according to the present invention is conceived in such a manner that it can be placed as close as possible in a (wall) corner region, at the same time allowing the drill stand 403 to be disposed as close as possible on the extraction unit 402.

Also shown in FIG. 6 are the wall or ceiling surface 442, 444. The first lateral surfaces 432, 434 of the suction unit 404, 406 are in turn disposed parallel to tangents of the annular extraction unit 402. The spacing between the second lateral surfaces of the first and second suction units 404, 406 is selected in such a way that the drill stand 403 can be placed as close as possible to the extraction unit 402. The spacing between the drill stand 403 is not limited, in particular not by the second lateral surfaces of the suction units 404, 406. Rather, the suction units 404, 406 are constructed in such a manner that the proximity of the drill stand 403 to the extraction unit 402 is also limited exclusively by the diameter of the annular extraction unit 402. The shape of the collection device 401 is adapted to a contour at the front end 405 of the drill stand 403.

FIG. 6 furthermore shows an alternative configuration of the first and the second suction unit unit 404, 406. These are illustrated schematically by lines 412, 414. While according to this alternative configuration, the first lateral surfaces 432, 434 also continue to extend tangentially to the annular suction unit 402 and perpendicularly to one another, the second and further lateral surfaces of the suction unit 404, 406 are designed in such a manner that they extend about the drill stand 403. In other words, the shape of the suction units 404, 406 is adapted to the external contour of the drill stand 403.

FIG. 7 shows a schematic illustration of a further core drilling system 500. The core drilling system 500 has a further embodiment of a collection device 501 according to the present invention. A drill stand 503 identical to the drill stand 403 is also part of the core drilling system 500 according to FIG. 7. Thus, only the collection device 501 according to FIG. 7 differs from the collection device 401 according to FIG. 6. In particular, the collection device 501 has an extraction unit 502 with a smaller diameter than is the case with the collection device 401 according to FIG. 6.

The collection device 501 according to FIG. 7 also has at least one suction unit. In FIG. 7, however, the suction unit is formed integrally. The suction unit of the collection device 501 has a first substantially triangular region 504 and a second substantially triangular region 506. The two triangular regions 504, 506 correspond substantially to the first and the second suction unit 404, 406 according to FIG. 6.

The two regions 504, 506 of the suction unit are connected to one another via a connecting region 514. In other words, the suction unit according to FIG. 7 is in one piece and does not require an air duct within the extraction unit 502 to generate a vacuum at both end regions 504, 506.

A first lateral surface 532 of the first region 504 is aligned tangentially to the suction unit 502 and perpendicular to a first lateral surface 534 of the second region 506. The first lateral surface 534 of the second region 506 is also aligned tangentially to the annular extraction unit 502. Thus, the first lateral surfaces 532, 534 of the collection device 501 are also mutually spaced apart in the circumferential direction, in particular over a range 510 which corresponds to an angle of 72°. On the opposite side of the external circumference of the annular extraction unit 502, the extraction unit 502 is completely covered by the suction unit.

The connecting region 514 is designed in such a manner that its width corresponds to the spacing of the rotation axis of the core drilling device fastened to the drill stand 503 from the front end of the drill stand 503, minus the radius of the annular extraction unit. In other words, a spacing 512 between the front end region of the drill stand 503 and the rotation axis of the core drilling device is not altered by the use of the collection device 501. Rather, in the embodiment according to FIG. 7, the smaller diameter of the extraction unit 502 is used to enlarge the surface of the suction unit in the direction of the drill stand. In this instance, the connecting region 514 can be arcuate, in particular with a radius which corresponds to the maximum spacing 512, i.e. the spacing of the rotation axis of the core drilling device from the front end region of the drill stand 503.

The present invention is not limited to the combination of features illustrated in the embodiments, but is derived from a combination of all the features disclosed herein.

1. A collection device for collecting drill sludge or dust created during the operation of a core drilling device, the collection device comprising:
an extraction unit with a drilling opening extending through the extraction unit and designed to receive a drill bit, wherein the extraction unit has a cavity extending at least partially about the drilling opening;
at least one suction unit connected to the extraction unit and is designed to form a vacuum chamber conjointly with a surface, the vacuum chamber being fluidically separated from the cavity of the extraction unit.

2. The collection device as recited in claim 1 wherein the extraction unit is of annular design.

3. The collection device as recited in claim 2 wherein the at least one suction unit covers between 40% and 75% of an external circumference of the extraction unit.

4. The collection device as recited in claim 2 wherein the at least one suction unit has a first and a second suction unit mutually spaced apart in a circumferential direction of the extraction unit.

5. The collection device as recited in claim 4 wherein the first suction unit has as axially symmetrical external contour in relation to the second suction unit.

6. The collection device as recited in claim 4 wherein the first suction unit is fluidically connected to the second suction unit.

7. The collection device as recited in claim 6 further comprising an air duct at least partially formed by the extraction unit to fluidly connect the first and second suction units.

8. The collection device as recited in claim 4 wherein the first suction unit has a first lateral surface extending perpendicularly to a first lateral surface of the second suction unit, wherein the first lateral surfaces of the first and second suction units are mutually spaced apart in the circumferential direction of the extraction unit.

9. The collection device as recited in claim 8 wherein the first lateral surfaces of the first and the second suction unit are disposed tangentially to an external circumference of the extraction unit.

10. The collection device as recited in claim 8 wherein the first suction unit has a second lateral surface opposite the first lateral surface and the second suction unit has a second lateral surface opposite the first lateral surface, and wherein the second lateral surfaces of the first and second suction units are mutually spaced apart in the circumferential direction of the extraction unit, wherein a spacing of the second lateral surfaces of the first and second suction units is sized in such a manner that at least a front part of a drill stand is disposable between the second lateral surfaces.

11. The collection device as recited in claim 1 wherein the at least one suction unit is of a triangular or partially annular design.

12. The collection device as recited in claim 1 wherein the at least one suction unit has a suction nozzle designed to be connected to a suction hose of a vacuum pump during operation.

13. The collection device as recited in claim 11 wherein the at least one suction unit has a seal for sealing a vacuum chamber in relation to the surface.

14. The collection device as recited in claim 13 wherein the suction nozzle is disposed on a surface of the suction body opposite the seal.

15. The collection device as recited in claim wherein the extraction unit has a seal for sealing the cavity in relation to the surface.

16. The collection device as recited in claim 1 wherein the extraction unit has at least one extraction opening disposed on an inner wall of the cavity and serves to extract drill sludge or dust from the cavity, wherein the extraction opening is connected to a suction nozzle via an extraction duct.

17. The collection device as recited in claim 16 wherein the suction nozzle is connected to an external circumference of the extraction unit.

18. The collection device as recited in claim 17 wherein the suction nozzle overlaps the at least one suction unit or is part of the at least one suction unit.
